(19) United States
(12) Patent Application Publication
(10) Pub. No.: US 2025/0313681 A1
(43) Pub. Date: Oct. 9, 2025

(54) SUBSTRATES WITH RESIN COMPOSITION ADHERED THERETO AND METHODS FOR IMPROVING ADHESION TO A SUBSTRATE

(71) Applicant: Momentive Performance Materials Inc., Niskayuna, NY (US)

(72) Inventors: Anne Dussaud, Tarrytown, NY (US); Rosemeire Ciro, São Paulo (BR)

(21) Appl. No.: 19/173,910

(22) Filed: Apr. 9, 2025

Related U.S. Application Data
(60) Provisional application No. 63/631,560, filed on Apr. 9, 2024.

(51) Int. Cl. C08K 5/5475; C08G 18/10; C08G 18/71; C08K 3/22; C08K 3/26; C08K 3/36; C08K 9/06; C09D 5/00; C09D 7/20; C09D 7/63; C09J 5/04; C09J 175/04

(52) U.S. Cl. CPC C08K 5/5475; C08G 18/10; C08G 18/718; C08K 3/36; C08K 9/06; C09D 5/002; C09D 7/20; C09D 7/63; C09J 5/04; C09J 175/04; C08K 2003/2241; C08K 2003/265

(57) ABSTRACT

A curable composition and substrate having adhered thereto a cured material formed from such compositions is shown and described herein. The curable composition comprises a curable resin and a nitrile silane. The inclusion of the nitrile silane in the curable composition has been found to enhance adhesion of curable compositions to substrates including to substrates that can be difficult to adhere to such as, for example, polymeric substrates and those that include zinc or zinc alloys.

### CROSS-REFERENCE TO RELATED APPLICATIONS

The present application claims priority to and the benefit of U.S. Provisional Application No. 63/631,560, titled “SUBSTRATES WITH RESIN COMPOSITION ADHERED THERETO AND METHODS FOR IMPROVING ADHESION TO A SUBSTRATE,” filed on Apr. 9, 2024, the disclosure of which is incorporated herein by reference.

### FIELD OF INVENTION

The present technology relates to a substrate having a curable composition adhered thereto and methods of improving adhesion to a substrate. In particular, the present technology provides a substrate having adhered thereto a curable resin composition comprising a nitrile silane additive.

### BACKGROUND

Many substrates, e.g. plastic based substrates, exhibit poor adhesion characteristics. Certain additives have been employed to improve the adhesion of a curable resin composition onto plastic substrates. Certain types of silanes such as, for example, aminosilanes, have been used to enhance adhesion of curable compositions to substrates. Aminosilanes may be useful to enhance dry adhesion of a curable composition to a substrate. Aminosilanes, however, typically do not provide sufficient wet adhesion (i.e., adhesion after immersion in water for a certain period of time).

Many conventional silanes can be useful for adhering to inorganic substrates such as, for example, aluminum, but are typically not very effective for aiding adhesion of curable compositions on substrates containing or coated with zinc or zinc alloys such as Aluzinc, galvanized steel, and the like.

Solvent based compositions may provide improved adhesion compared to the composition having 100% solids. Solvents are volatile components, and there is a trend to move away from solvent based systems for environmental reasons.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure.

In one aspect, provided is a substrate having adhered to at least a portion of a surface thereof a curable composition comprising a curable polymer resin and a nitrile silane. In one embodiment, the nitrile silane is a cyanoalkylalkoxysilane. Applicant has surprisingly found that curable compositions with a nitrile silane additive provide enhanced adhesion to substrates that do not as readily adhere compositions that contain conventional silane additives. In particular it has been found that the curable compositions with a nitrile silane provide enhanced adhesion, and particularly enhanced wet adhesion, to polymeric substrates and substrates that include zinc or zinc alloys.

In one embodiment, the curable composition comprises: (a) a curable resin comprising a polymer that is reactive with water; and (b) a nitrile silane.

In one embodiment, the nitrile silane is a cyanoalkylalkoxysilane of the formula:

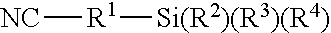

where R¹ is selected from a C1-C20 bivalent hydrocarbon group; R², R³, and R⁴ are each independently selected from C1-30 monovalent hydrocarbon, a halide, and —OR⁵, where R⁵ is independently selected from a C1-30 monovalent hydrocarbon, with the proviso that at least one of R², R³, and R⁴ is selected from —OR⁵.

In one embodiment, R¹ is selected from a C1-C20 alkylene; R², R³, and R⁴ are each independently selected from a C1-C20 alkyl, a C4-C20 cycloalkyl, and a C6-C30 aryl; and R⁵ is independently selected from a C1-C20 alkyl.

In one embodiment, R¹ is selected from a C1-C20 alkylene; each of R², R³, and R⁴ is selected from a C1-C10 alkyl, and R⁵ is selected from a C1-C10 alkyl.

In one embodiment, R¹ is selected from a C1-C4 alkylene, and each of R², R³, and R⁴ is selected from —OR⁵, where R⁵ is independently selected from a C1-C4 alkyl.

In one embodiment of the curable composition in accordance with any of the previous embodiments, the cyanoalkylalkoxysilane is selected from 2-cyanoethyltrimethoxysilane, 2-cyanoethyltriethoxysilane, 2-cyanoethyltripropoxysilane, 2-cyanoethyldimethoxymethylsilane, 2-cyanoethyldimethoxyethylsilane, 2-cyanoethyldiethoxymethylsilane, 2-cyanoethyldiethyoxyethylsilane, 3-cyanopropyltrimethoxysilane, 3-cyanopropyltriethoxysilane, 3-cyanopropyltripropoxysilane, 3-cyanopropyldimethoxymethylsilane, 3-cyanopropyldimethoxyethylsilane, 3-cyanodiethoxymethylsilane, 3-cyanopropyldiethoxyethylsilane, or a combination of two or more thereof.

In one embodiment of the curable composition in accordance with any of the previous embodiments, the cyanoalkylsilane is present in an amount of from about 0.1 wt. % to about 20 wt. % based on the total weight of the curable composition.

In one embodiment of the curable composition in accordance with any of the previous embodiments, the cyanoalkylsilane is present in an amount of from about 0.5 wt. % to about 10 wt. % based on the total weight of the curable composition.

In one embodiment, the curable resin (a) is selected from a silylated polyol; a silylated polyether; a silylated polyurethane; a silane-containing copolymer derived from the copolymerization of an ethylenically unsaturated silane selected from a vinylsilane, an allylsilane, a methallylsilane, an acryloxyalkylsilane, a methacryloxyalkylsilane, and an ethylenically unsaturated monomer selected from an olefinic hydrocarbon, an acrylic acid, a methacrylic acid, an acrylate ester, a methacrylate ester, an ethylenically unsaturated dicarboxylic acid, and/or an anhydride of the ethylenically unsaturated monomer, oligomers, and/or a polymer possessing ethylenic unsaturation; a combination of two or more thereof.

In one embodiment in accordance with any of the previous embodiments, the curable resin (a) is selected from a silylated polyurethane.

In one embodiment in accordance with any of the previous embodiments, the composition further comprises an additive selected from a pigment, a filler, a curing catalyst, a dye, a plasticizer, a thickener, a coupling agent, an extender, a solvent, a wetting agent, a tackifiers, a crosslinking agent, a thermoplastic polymer, an adhesion promoter, a UV stabilizer, a thixotropic agent, an antioxidant, a flame retardant, or a combination of two or more thereof.

In another aspect, provided is a method of treating a substrate comprising applying a curable composition comprising a curable polymer and a nitrile silane to a surface of the substrate.

In a further aspect, provided is a primer composition comprising a solvent and a nitrile silane.

In one aspect, provided is a A substrate having adhered to at least a portion of a surface of the substrate a cured composition obtained from a curable composition, wherein the curable composition comprises (a) a curable resin comprising a polymer; and (b) a nitrile silane.

In one embodiment, the nitrile silane is a cyanoalkylalkoxysilane of the formula:

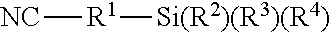

where R¹ is selected from a C1-C20 bivalent hydrocarbon group; R², R³, and R⁴ are each independently selected from C1-30 monovalent hydrocarbon, a halide, and —OR⁵, where R⁵ is independently selected from a C1-30 monovalent hydrocarbon, with the proviso that at least one of R², R³, and R⁴ is selected from —OR⁵.

In one embodiment, R¹ is selected from a C1-C20 alkylene; R², R³, and R⁴ are each independently selected from a C1-C20 alkyl, a C4-C20 cycloalkyl, and a C6-C30 aryl; and R⁵ is independently selected from a C1-C20 alkyl.

In one embodiment, R¹ is selected from a C1-C20 alkylene; each of R², R³, and R⁴ is selected from a C1-C10 alkyl, and R⁵ is selected from a C1-C10 alkyl.

In one embodiment, R¹ is selected from a C1-C4 alkylene, and each of R², R³, and R⁴ is selected from —OR⁵, where R⁵ is independently selected from a C1-C4 alkyl.

In one embodiment, the cyanoalkylalkoxysilane is selected from 2-cyanoethyltrimethoxysilane, 2-cyanoethyltriethoxysilane, 2-cyanoethyltripropoxysilane, 2-cyanoethyldimethoxymethylsilane, 2-cyanoethyldimethoxyethylsilane, 2-cyanoethyldiethoxymethylsilane, 2-cyanoethyldiethyoxyethylsilane, 3-cyanopropyltrimethoxysilane, 3-cyanopropyltriethoxysilane, 3-cyanopropyltripropoxysilane, 3-cyanopropyldimethoxymethylsilane, 3-cyanopropyldimethoxyethylsilane, 3-cyanodiethoxymethylsilane, 3-cyanopropyldiethoxyethylsilane, or a combination of two or more thereof.

In one embodiment in accordance with any previous embodiment, the cyanoalkylalkoxysilane is present in an amount of from about 0.1 wt. % to about 20 wt. % based on the total weight of the curable composition.

In one embodiment in accordance with any previous embodiment, the cyanoalkylalkoxysilane is present in an amount of from about 0.5 wt. % to about 10 wt. % based on the total weight of the curable composition.

In one embodiment in accordance with any previous embodiment, the cyanoalkylalkoxysilane is present in an amount of from about 1 wt. % to about 5 wt. % based on the total weight of the curable composition.

In one embodiment in accordance with any previous embodiment, the curable resin is selected from a polymer selected from a polyepoxide; a polyolefin; a polyvinylchloride; a polyester; a polyurethane; a polyamide; a polyfluoroalkene; a polyether; a polyacrylate; a polymethacrylate; a polysiloxane; a silylated polyol; a silylated polyether; a silylated polyurethane; a silane-containing copolymer derived from the copolymerization of an ethylenically unsaturated silane selected from a vinylsilane, an allylsilane, a methallylsilane, an acryloxyalkylsilane, a methacryloxyalkylsilane, and an ethylenically unsaturated monomer selected from an olefinic hydrocarbon, an acrylic acid, a methacrylic acid, an acrylate ester, a methacrylate ester, an ethylenically unsaturated dicarboxylic acid, and/or an anhydride of the ethylenically unsaturated monomer, oligomers, and/or a polymer possessing ethylenic unsaturation; a combination of two or more thereof.

In one embodiment in accordance with any previous embodiment, the curable resin is selected from a silylated polyurethane.

In one embodiment, the silylated polyurethane is selected from a polymer of the formula:

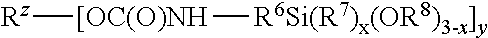

where R^{z} is an organic polymer fragment, R⁶ is an alkylene group of up to 12 carbon atoms, optionally containing one or more heteroatoms, each R⁷ is the same or different alkyl or aryl group of up to 8 carbon atoms, each R⁸ is the same or different alkyl group of up to 6 carbon atoms, x is 0, 1 or 2, and y is 1 to 6.

In one embodiment, R¹ is selected from a C1-C20 linear or branched bivalent hydrocarbon group; R², R³, and R⁴ are each independently selected from a C1-C10 alkyl; where R⁵ is selected from a C1-C10 alkyl.

In one embodiment, each of R², R³, and R⁴ is selected from a C1-C20 alkyl, a C4-C20 cycloalkyl, a C6-C30 aryl, or —OR⁵.

In one embodiment, R¹ is selected from a C1-C20 linear or branched bivalent hydrocarbon group, and each of R², R³, and R⁴ is selected from —OR⁵, where R⁵ is independently selected from a C1-C4 alkyl.

In one embodiment in accordance with any previous embodiment, the substrate is selected from a polymeric substrate or an inorganic substrate.

In one embodiment in accordance with any previous embodiment, the substrate is a polymeric substrate selected from a phenol resin, an epoxy resin, a polycarbonate (PC), a polyolefin, a polystyrene, an acrylonitrile-butadiene-styrene resin, an acrylic resin, a polyvinyl alcohol, a polyester, a polyvinyl chloride, a polyurethane, a polyimide, a synthetic rubber, a natural rubber, a silicon polymer, or a combination of two or more thereof.

In one embodiment in accordance with any previous embodiment, the substrate is selected from a polymethyl(meth)acrylate (PMMA), a ketone ethyl ester (KEE), a polyethylene terephthalate (PET), polyvinyl chloride, acrylonitrile-butadiene-styrene, or a combination of two or more thereof.

In one embodiment in accordance with any previous embodiment, the substrate is selected from a zinc coated substrate, steel, an Aluzinc coated substrates, galvanized steel, or a combination of two or more thereof.

In one embodiment in accordance with any previous embodiment, the composition further comprises an additive selected from a pigment, a filler, a curing catalyst, a dye, a plasticizer, a thickener, a coupling agent, an extender, a solvent, a wetting agent, a tackifiers, a crosslinking agent, a thermoplastic polymer, an adhesion promoter, a UV stabilizer, or a combination of two or more thereof.

In one embodiment in accordance with any previous embodiment, the curable composition is free of a solvent.

In one embodiment in accordance with any previous embodiment, the cured composition has a wet peel strength that is at least 50% greater than the same composition that does not contain the nitrile silane when adhered to a polyethylene terephthalate substrate or an Aluzinc substrate, wherein the wet peel strength is measured according to ASTM C794 following one week of immersion in water at a temperature of from about 19° C. to about 25° C.

In one embodiment in accordance with any previous embodiment, the cured composition has a wet peel strength that is from 50% to about 350% greater than the same composition that does not contain the nitrile silane when adhered to a polyethylene terephthalate substrate or an Aluzinc substrate, wherein the wet peel strength is measured according to ASTM C794 following one week of immersion in water at a temperature of from about 19° C. to about 25° C.

In another aspect, provided is a primer composition comprising a nitrile silane and a solvent.

In one embodiment, the nitrile silane is a cyanoalkylalkoxysilane of the formula:

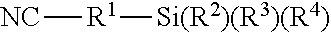

where R¹ is selected from a C1-C20 bivalent hydrocarbon group; R², R³, and R⁴ are each independently selected from C1-30 monovalent hydrocarbon, a halide, and —OR⁵, where R⁵ is independently selected from a C1-30 monovalent hydrocarbon, with the proviso that at least one of R², R³, and R⁴ is selected from —OR⁵.

In one embodiment, R¹ is selected from a C1-C20 alkylene; R², R³, and R⁴ are each independently selected from a C1-C20 alkyl, a C4-C20 cycloalkyl, and a C6-C30 aryl; and R⁵ is independently selected from a C1-C20 alkyl.

In one embodiment, R¹ is selected from a C1-C20 alkylene; each of R², R³, and R⁴ is selected from a C1-C10 alkyl, and R⁵ is selected from a C1-C10 alkyl.

In one embodiment, R¹ is selected from a C1-C4 alkylene, and each of R², R³, and R⁴ is selected from —OR⁵, where R⁵ is independently selected from a C1-C4 alkyl.

In one embodiment in accordance with any previous embodiment, the cyanoalkylalkoxysilane is selected from 2-cyanoethyltrimethoxysilane, 2-cyanoethyltriethoxysilane, 2-cyanoethyltripropoxysilane, 2-cyanoethyldimethoxymethylsilane, 2-cyanoethyldimethoxyethylsilane, 2-cyanoethyldiethoxymethylsilane, 2-cyanoethyldiethyoxyethylsilane, 3-cyanopropyltrimethoxysilane, 3-cyanopropyltriethoxysilane, 3-cyanopropyltripropoxysilane, 3-cyanopropyldimethoxymethylsilane, 3-3-cyanodiethoxymethylsilane, 3-cyanopropyldimethoxyethylsilane, cyanopropyldiethoxyethylsilane, or a combination of two or more thereof.

In one embodiment in accordance with any previous embodiment, the solvent is selected from diacetone alcohol, propylene glycol monomethyl ether; ethylene glycol monomethyl ether, propylene glycol monoethyl ether, ethylene glycol monoethyl ether, isobutyl alcohol, ethanol, isopropyl alcohol, n-butyl alcohol, n-propyl alcohol, acetone, methyl ethyl ketone, methyl isobutyl ketone, acetylacetone, ethyl acetate, butyl acetate, xylene, toluene, or a combination of two or more thereof.

In one embodiment in accordance with any previous embodiment, the primer composition further comprises water. In one embodiment, the water is present in an amount of from about 0.1 wt. % to about 10 wt. % based on the total weight of the primer composition.

In one embodiment in accordance with any previous embodiment, the solvent is water.

In one embodiment in accordance with any previous embodiment, the nitrile silane is present in an amount of from about 0.1 wt. % to about 10 wt. % based on the total weight of the primer composition.

In still another aspect, provided is a method of adhering a first substrate to a second substrate comprising applying the primer composition of any of any of the previous embodiments to a surface of the first substrate and to a surface of the second substrate; applying a curable polymer composition over the primer composition on the first or second substrate; and bonding the first and second substrate.

The following description and the drawings disclose various illustrative aspects. Some improvements and novel aspects may be expressly identified, while others may be apparent from the description and drawings.

### DETAILED DESCRIPTION

Reference will now be made to exemplary embodiments, examples of which are described in the following detailed description. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

The terms “polymer” and “resin” or “polymer resin” as used herein are used interchangeably with one another.

Values for the ranges of a respective component can be combined to form new and non-specified ranges.

Provided is a substrate having a resin composition adhered to at least a portion of a surface of the substrate, where the resin composition comprises (a) a curable polymer and (b) a nitrile functional silane. In one embodiment, the nitrile silane is a (cyanoalkyl)alkoxysilane. The (cyanoalkyl)alkoxysilanes have been found to enhance adhesion of resin compositions and particularly on substrates that are difficult to adhere to and/or substrates where conventional silane additives do not provide a benefit. The improved adhesion may be in the form of adhesion to substrates where little or no adhesion is observed with a conventional silane, and/or to improved wet adhesion.

The curable composition includes a nitrile silane as an additive. In embodiments, the nitrile silane is selected from a cyanoalkylalkoxysilane. In one embodiment, the cyanoalkylalkoxysilane is selected from a compound of the formula:

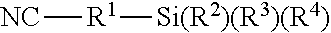

where R¹ is selected from a C1-C20 bivalent hydrocarbon group; R², R³, and R⁴ are each independently selected from a C1-C30 monovalent hydrocarbon, a halide, and —OR⁵, where R⁵ is selected from a C1-C20 monovalent hydrocarbon, with the proviso that at least one of R², R³, and R⁴ is selected from halide or —OR⁵.

The bivalent and monovalent hydrocarbons can be selected from linear, branched, or cyclic hydrocarbons. Branched hydrocarbons generally contain 3 or more carbon atoms. Cyclic hydrocarbons generally comprise 4 or more carbon atoms. The cyclic hydrocarbons may also include one or more unsaturated C—C bonds and, in embodiments, may include one or more aromatic. In one embodiment, the monovalent hydrocarbon is selected from an alkyl, a cycloalkyl, and an aryl. In one embodiment, the bivalent hydrocarbon is selected from an alkylene. The alkylene may include cycloalkylenes. The halide can be selected from chloride, bromide, or iodide.

In one embodiment, R¹ is selected from a C1-C20 alkylene; R², R³, and R⁴ are each independently selected C1-C20 alkyl, a C4-C20 cycloalkyl, a C6-C30 aryl; and R⁵ is selected from a C1-C20 alkyl.

Cycloalkyls include a group with one or more cycloalkyl rings that may be separated by a bond, a linker group, or fused and optionally contain one or more groups (e.g., an alkyl, alcohol, etc.) attached to the ring. The aryl groups include groups with one or more aromatic rings, where groups with more than one ring may be joined by a bond, a linker group, or fused and can optionally contain one or more groups (e.g., an alkyl, alcohol, etc.) attached to the ring. The C6-C30 aryl groups can include, for example, C7-C30 arylalkyl groups and C7-C30 alkylaryl groups.

In one embodiment, R¹ is selected from a C1-C10 alkylene, a C2-C8 alkylene, or a C3-C6 alkylene; R², R³, and R⁴ are each independently selected from a C1-C10 alkyl, C3-C8 alkyl, a C4-C6 alkyl, and —OR⁵, where R⁵ is selected from a C1-C10 alkyl, a C2-C8 alkyl, or a C3-C6 alkyl. In one embodiment, R¹ is selected from a C2 alkylene; R², R³, and R⁴ are each a C1 alkyl; and R⁵ is a C1 alkyl.

In one embodiment, R¹ is selected from a C1-C20 alkylene, and each of R², R³, and R⁴ is selected from —OR⁵, where R⁵ is independently selected from a C1-C20 alkyl, a C4-C20 cycloalkyl, and a C6-C30 aryl. In one embodiment, R¹ is selected from a C2-C4 alkylene, and each of R², R³, and R⁴ is selected from —OR⁵, where R⁵ is independently selected from a C2-C4 alkyl.

Examples of suitable cyanoalkyl alkoxysilanes include, but are not limited to, cyanomethyltrimethoxysilane, cyanomethyltriethoxysilane, cyanomethyltripropoxysilane, 2-cyanoethyltrimethoxysilane, 2-cyanoethyltriethoxysilane, 2-cyanoethyltripropoxysilane, 2-cyanoethyldimethoxymethylsilane, 2-cyanoethyldimethoxyethylsilane, 2-cyanoethyldiethoxymethylsilane, 2-cyanoethyldiethyoxyethylsilane, 3-cyanopropyltrimethoxysilane, 3-cyanopropyltriethoxysilane, 3-cyanopropyltripropoxysilane, 3-cyanopropyldimethoxymethylsilane, 3-cyanopropyldimethoxyethylsilane, 3-cyanopropyldiethoxymethylsilane, 3-cyanopropyldiethoxyethylsilane, and the like, or combinations of two or more thereof.

The nitrile silane is present in the composition in an amount of from about 0.1 wt. % to about 20 wt. %, from about 0.5 wt. % to about 15 wt. %, from about 0.75 wt. % to about 10 wt. %, or from about 1 wt. % to about 5 wt. % based on the total weight of the curable composition.

The curable composition comprises a curable polymer resin. The curable polymer resin may be referred to herein and used interchangeably with the terms “curable polymer,” “curable resin,” “polymer resin,” or the “polymer.” The curable resin is not particularly limited and can be selected as desired for a particular purpose or intended application. The curable resin may be selected from a thermoset or thermoplastic resin. Generally, the curable resin may be selected from any polymeric resin or system that may undergo curing to a crosslinked material. The curable resin may be cured by any appropriate mechanism such as, for example, addition curing, condensation (moisture) curing, UV curing, and the like. The curing may involve two types of cure, for example UV cure and moisture cure, addition cure and moisture cure. The base structure, repeating unit, or backbone of the polymer is generally not limited and can be selected as desired for a particular purpose or intended application. In embodiments, the curable resin is selected from an organic polymer. The organic polymer is one comprising carbon. The curable resin can include functional groups such as, but not limited to, epoxy, amine, ester, vinyl, amide, urethane, urea, mercaptan, carboxylic acid, acryloyl, methyacryloyl, isocyanate, alkoxysilyl, anhydride, hydroxyl, alkoxy, and the like. In one embodiment, the curable resin comprises a polymer selected from a polyepoxide, a polyolefin, a polyvinylchloride, a polyester, a polyurethane, a polyamide, a polyfluoroalkene, a polyether, a polyacrylic, a polymethacrylic, a polysiloxane, and the like.

Examples of a curable thermoset material include, but are not limited to, epoxy resins, acrylate resins, that may form cross-linking networks via free radical polymerization, atom transfer, radical polymerization, ring-opening polymerization, ring-opening metathesis polymerization, or anionic polymerization, cationic polymerization. Suitable curable silicone resins may include, for example, the addition curable and condensation curable matrices.

Examples of suitable polymeric thermoplastic resins for the resin component include, but are not limited to, styrene-based polymers such as polystyrene (including atactic, syndiotactic and isotactic polystyrene), halogen-substituted styrene polymers, styrene acrylonitrile copolymers, acrylonitrile-butadiene-styrene (ABS) resins, styrene-butadiene copolymers, styrene-butadiene-styrene (SBS) block copolymers, blends of styrene-acrylonitrile copolymer and ethylene-styrene interpolymer, polycarbonate/acrylonitrile-butadiene-styrene terpolymer alloys, and SEBS resins, polyacrylonitrile, condensation polymers such as polyesters including polyethylene terephthalate, polybutylene terephthalate (PBT), polyacrylate, and the like, polycarbonates (including impact-modified polycarbonate), polyethers such as polyphenyleneoxide, maleic anhydride grafted polyphenyleneoxide, maleic anhydride grafted olefinic elastomers and plastomers, polysulfone, polyethersulfone, polyarylsulfone, polyphenylene ether, and the like, condensed polymers such as polyamide (6, 6/6, 6/10, 6/12, 11 or 12, and the like) and polyoxymethylene, polyphenylenesulfide (PPS), acryl-based polymers such as polyacrylic acid, poly(n-butyl methacrylate), poly(n-butyl acrylate), and polymethyl methacrylate, halogen-substituted acrylates such as hexafluorobutyl methacrylate and hexafluorobutyl acrylate polyacrylamides, polyolefins such as polyethylene (low density polyethylene (LDPE), medium and high density polyethylene, linear low density polyethylene (LLDPE), high density polyethylene (HDPE), and the like), polypropylene (including isotactic polypropylene and blends of isotactic polypropylene and syndiotactic polypropylene) blends of isotactic polypropylene and polyethylene, polybutene, poly(4-methylpentene-1), ethylene-propylene copolymers, poly(ethylene/1-butylene), poly(propylene/1-butylene), poly(ethylene/propylene/1-butylene), poly(ethylene butyrate), and poly(polyethylene naphthalate), halogen substituted vinyl polymers such as polyhexafluoropropylene, polytetrafluoroethylene, polyvinylidene fluoride, polyvinyl chloride, polyvinylidene chloride, polyvinyl fluoride, polyvinylidene dichloride, vinylidene chloride-vinyl chloride copolymers, vinylidene chloride-methylacrylate copolymers, and the like, polyvinylmethylether, other vinyl containing compounds such as ethylene-vinyl alcohol polymers and polyvinyl alcohols, ethylene vinyl acetate, and other vinyl containing compounds having an epoxy group, such as glycidyl methacrylate, glycidyl acrylate, vinyl glycidyl ether, glycidyl ether of hydroxyalkyl (meth)acrylate, glycidyl ether of polyalkyleneglycol (meth)acrylate, and glycidylitaconate, among which glycidyl methacrylate is particularly preferred. Also included, for example, are copolymers of styrene and substituted styrene (e.g., styrene/p-methylstyrene copolymers. These copolymers can be atactic, isotactic, or syndiotactic. Organic polymers suitable for use in this composition may be, but are not limited to, epoxy-functional resins for example resins based on the diglycidylether of bisphenol A or epoxy-functional polysiloxanes, vinyl ester resins for example, (meth)acrylate resins, vinyl-functional resins, for example vinyl-functional polysiloxanes and unsaturated polyesters, polyols, alkyds, and alkoxysilyl-functional organic resins, or combinations thereof. Suitable epoxy-functional resins include (i) polyglycidyl ethers derived from such polyhydric alcohols as ethyleneglycol, diethyleneglycol, triethyleneglycol, 1,2-propyleneglycol, 1,4-butyleneglycol, 1,5-pentanediol, 1,2,6-hexanetriol, glycerol, trimethylolpropane, bisphenol-A (a condensation product of acetone and phenol), bisphenol-F (a condensation product of phenol and formaldehyde), hydrogenated bisphenol-A, or hydrogenated bisphenol-F, (ii) polyglycidyl ethers of polycarboxylic acids, formed by the reaction of an epoxy compound such as epichlorohydrin with an aliphatic or aromatic polycarboxylic acid such as oxalic acid, succinic acid, glutaric acid, terephthalic acid, 2,6-napthalene dicarboxylic acid, or dimerised linoleic acid, (iii) epoxidised olefinically unsaturated alicyclic materials such as epoxy alicyclic ethers and esters, (iv) epoxy resins containing oxyalkylene groups, (v) epoxy novolac resins, which are prepared by reacting an epihalohydrin (e.g. epichlorohydrin) with the condensation product of an aldehyde with a monohydric or polyhydric phenol (e.g. phenolformaldehyde condensate), (vi) any of the aforementioned epoxy-functional resins modified with polysiloxane side groups, (vii) a silicate modified epoxy resin, for example the reaction product of a tetraalkoxyorthosilicate or a partially condensed oligomer thereof and an epoxy resin containing hydroxyl groups as described in WO 2009/019296, which is incorporated herein by reference in its entirety, and (viii) mixtures thereof.

The organic polymers may also be, for example, (meth)acrylate polymers including polymers having terminal acrylate or methacrylate groups. Examples of suitable (meth)acrylate-functional polymers are urethane acrylates, acrylate or methacrylate esters derived from an epoxy resin, polyol acrylates, polyether acrylates, polyester acrylates, melamine resin acrylate, polyamide acrylate, acrylic polymers having pendant acrylic groups, and silicone acrylates.

In one embodiment, the curable polymer is a moisture-curable polymer. In embodiments, the moisture-curable polymer is a polymer resin comprising a hydrolysable silyl group. These may also be referred to as silylated polymers. Examples of suitable silylated polymers include, but are not limited to, silylated polyols, silylated polyethers, silylated polyurethane resins and silane-containing copolymers derived from the copolymerization of one or more ethylenically unsaturated silanes such as vinylsilanes, allylsilanes and methallylsilanes, acryloxyalkylsilane, methacryloxyalkylsilanes and one or more other ethylenically unsaturated monomers such as olefinic hydrocarbons, acrylic acid, methacrylic acid, acrylate ester, methacrylate ester, ethylenically unsaturated dicarboxylic acids and/or their anhydrides, oligomers and/or polymers possessing ethylenic unsaturation, and the like. In one embodiment, the moisture-curable polymer is selected from a silylated polyurethane resin (SPUR). The moisture-curable polyurethane is not particularly limited and can be selected as desired for a particular purpose or intended application.

For silylated resins, the resin can be formed by reacting an appropriate silane functional material with a precursor resin. Such suitable precursor resins will be generally known or determinable by those skilled in the art. In one embodiment, suitable precursor resins include (i) polyether polyols, (ii) polyester polyols, (iii) hydroxyl-terminated polybutadienes, (iv) hydroxyl-terminated and isocyanate-terminated polyurethane prepolymers derived from any of the foregoing, (v) isocyanate-terminated and amine-terminated polyurethane-polyurea (poly(urethane-urea) or polyurethaneurea) prepolymers and polyurea prepolymers derived from polyamines, and (vi) olefinically unsaturated polymers that are capable of undergoing hydrosilation with hydridrosilanes, e.g., polyolefins and polyethers possessing terminal olefinic unsaturation. The resin can be obtained by silylating these and similar precursor resins in any now known or later discovered manner. Some current existing processes for obtaining silylated resins include, e.g., silylating a hydroxyl-terminated resin by reaction with an isocyanatosilane, silylating an isocyanate-terminated resin with a silane possessing functionality that is reactive for isocyanate such as mercapto or amino functionality, and silylating an olefinically unsaturated resin by reaction with a hydridosilane (hydrosilane) under hydrosilation reaction conditions.

It will be appreciated that the composition may include one or more curing agent(s) for the organic polymers. The polymer(s) forms a coating layer on a substrate by reacting (cross-linking reaction) with the curing agent(s). The choice of curing agent is not particularly limited, except that it must comprise functional groups suitable for reacting with the functional groups on the thermosetting resins in order to affect cross-linking. Determination of a suitable curing agent is within the general skill set and knowledge of a skilled person who formulates coating compositions. For example, for epoxy functional organic resins, suitable curing agents comprise amine, or thiol functional groups, preferably amine functional groups. Suitable examples are phenol resin curing agents, polyamine curing agents, polythiol curing agents, polyanhydride curing agents, and polycarboxylic acid curing agents.

In one embodiment, the moisture-curable resin is a silylated SPUR resin such as, but not limited to, those described in U.S. Pat. No. 5,990,257 and can be made by any of the methods described therein, the entire contents of which are incorporated herein by reference in their entirety.

Isocyanate-terminated PUR prepolymers can be obtained by reacting one or more polyols, advantageously, diols, with one or more polyisocyanates, advantageously, diisocyanates, in such proportions that the resulting prepolymers will be terminated with isocyanate. In the case of reacting a diol with a diisocyanate, a molar excess of diisocyanate will be employed.

Included among the polyols that can be utilized for the preparation of the isocyanate-terminated PUR prepolymer are polyether polyols, polyester polyols such as the hydroxyl-terminated polycaprolactones, polyetherester polyols such as those obtained from the reaction of polyether polyol with e-caprolactone, polyesterether polyols such as those obtained from the reaction of hydroxyl-terminated polycaprolactones with one or more alkylene oxides such as ethylene oxide and propylene oxide, hydroxyl-terminated polybutadienes, and the like.

Specific suitable polyols that can be utilized for the preparation of the isocyanate-terminated PUR prepolymer include the poly(oxyalkylene) ether diols (i.e., polyether diols), in particular, the poly(oxyethylene) ether diols, the poly(oxypropylene) ether diols and the poly(oxyethylene-oxypropylene) ether diols, poly(oxyalkylene) ether triols, poly(tetramethylene) ether glycols, polyacetals, polyhydroxy polyacrylates, polyhydroxy polyester amides, polyhydroxy polythioethers, polycaprolactone diols and triols, and the like. In one embodiment of the present invention, the polyols used in the production of the isocyanate-terminated PUR prepolymers are poly(oxyethylene) ether diols with equivalent weights from about 500 to about 25,000. In another embodiment of the present invention, the polyols used in the production of the isocyanate-terminated PUR prepolymers are poly(oxypropylene) ether diols with equivalent weights from about 1,000 to about 20,000. Mixtures of polyols of various structures, molecular weights and/or functionalities can also be used.

The polyether polyols can have a functionality up to about 8 but advantageously have a functionality of from 2 to 4 and more advantageously, a functionality of 2 (i.e., diols). Especially suitable are the polyether polyols prepared in the presence of double-metal cyanide (DMC) catalysts, an alkaline metal hydroxide catalyst, or an alkaline metal alkoxide catalyst; see, for example, U.S. Pat. Nos. 3,829,505, 3,941,849, 4,242,490, 4,335,188, 4,687,851, 4,985,491, 5,096,993, 5,100,997, 5,106,874, 5,116,931, 5,136,010, 5,185,420 and 5,266,681, the entire contents of each of the foregoing patents are incorporated herein by reference in their entireties. In one embodiment, the polyether polyols preferably have a number average molecular weight of from about 1,000 to about 25,000, more preferably from about 2,000 to about 20,000, and even more preferably from about 4,000 to about 18,000. Examples of commercially available diols that are suitable for making the isocyanate-terminated PUR prepolymer include ARCOL R-1819 (number average molecular weight of 8,000), E-2204 (number average molecular weight of 4,000), and ARCOL E-2211 (number average molecular weight of 11,000).

Any of numerous polyisocyanates, advantageously, diisocyanates, and mixtures thereof, can be used to provide the isocyanate-terminated PUR prepolymers. In one embodiment, the polyisocyanate can be diphenylmethane diisocyanate (“MDI”), polymethylene polyphenylisocyanate (“PMDI”), paraphenylene diisocyanate, naphthylene diisocyanate, liquid carbodiimide-modified MDI and derivatives thereof, isophorone diisocyanate, dicyclohexylmethane-4,4′-diisocyanate, toluene diisocyanate (“TDI”), particularly the 2,6-TDI isomer, as well as various other aliphatic and aromatic polyisocyanates that are well-established in the art, and combinations thereof.

Silylation reactants for reacting with the isocyanate-terminated PUR prepolymers described above include functionality that is reactive with isocyanate and at least one readily hydrolyzable and subsequently crosslinkable group, e.g., alkoxy. Particularly useful silylation reactants are the silanes of the general formula:

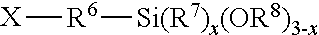

wherein X is an active hydrogen-containing group that is reactive for isocyanate, e.g., —SH or —NHR⁹ in which R⁹ is H, a monovalent hydrocarbon group of up to 8 carbon atoms or —R¹⁰—Si(R¹¹)_{y}(OR¹²)_{3-y}, R⁶ and R¹⁰ each is the same or different divalent hydrocarbon group of up to 12 carbon atoms, optionally containing one or more heteroatoms, each R⁷ and R¹¹ is the same or different monovalent hydrocarbon group of up to 8 carbon atoms, each R⁸ and R¹² is the same or different alkyl group of up to 6 carbon atoms and x and y each, independently, is 0, 1 or 2.

Examples of silanes that can be used as reactants to silylate a resin include, but are not limited to, the mercaptosilanes 2-mercaptoethyl trimethoxysilane, 3-mercaptopropyl trimethoxysilane, 2-mercaptoethyl triethoxysilane, 3-mercaptopropyl triethoxysilane, 2-mercaptoethyl tripropoxysilane, 2-mercaptoethyl tri sec-butoxysilane, 3-mercaptopropyl tri-t-butoxysilane, 3-mercaptopropyl triisopropoxysilane, 3-mercaptopropyl trioctoxysilane, 2-mercaptoethyl tri-2′-ethylhexoxysilane, 2-mercaptoethyl dimethoxy ethoxysilane, 3-mercaptopropyl methoxyethoxypropoxysilane, 3-mercaptopropyl dimethoxy methylsilane, 3-mercaptopropyl methoxy dimethylsilane, 3-mercaptopropyl ethoxy dimethylsilane, 3-mercaptopropyl diethoxy methylsilane, 3-mercaptopropyl cyclohexoxy dimethyl silane, 4-mercaptobutyl trimethoxysilane, 3-mercapto-3-methylpropyltrimethoxysilane, 3-mercapto-3-methylpropyl-tripropoxysilane, 3-mercapto-3-ethylpropyl-dimethoxy methylsilane, 3-mercapto-2-methylpropyl t 3-mercapto-2-methylpropyl dimethoxyphenylsilane, 3-mercaptocyclohexyl-trimethoxysilane, 12-mercaptododecyl trimethoxy silane, 12-mercaptododecyl-triethoxy silane, 18-mercaptooctadecyl trimethoxysilane, 18-mercaptooctadecyl methoxydimethylsilane, 2-mercapto-2-methylethyl-tripropoxysilane, 2-mercapto-2-methylethyl-trioctoxysilane, 2-mercaptophenyl trimethoxysilane, 2-mercaptophenyl triethoxysilane, 2-mercaptotolyl trimethoxysilane, 2-mercaptotolyl triethoxysilane, 1-mercaptomethyltolyl trimethoxysilane, 1-mercaptomethyltolyl triethoxysilane, 2-mercaptoethylphenyl trimethoxysilane, 2-mercaptoethyiphenyl triethoxysilane, 2-mercaptoethyltolyl trimethoxysilane, 2-mercaptoethyltolyl triethoxysilane, 3-mercaptopropylphenyl trimethoxysilane and, 3-mercaptopropylphenyl triethoxysilane, and the aminosilanes 3-aminopropyltrimethoxysilane, 3-aminopropyltriethoxysilane, 4-aminobutyltriethoxysilane, N-methyl-3-amino-2-methylpropyltrimethoxysilane, N-ethyl-3-amino-2-methylpropyltrimethoxysilane, N-ethyl-3-amino-2-methylpropyldiethoxymethylsilane, N-ethyl-3-amino-2-methylpropyltriethoxysilane, N-ethyl-3-amino-2-methylpropylmethyldimethoxysilane, N-butyl-3-amino-2-methylpropyltrimethoxysilane, 3-(N-methyl-2-amino-1-methyl-1-ethoxy)-propyltrimethoxysilane, N-ethyl-4-amino-3,3-dimethyl-butyldimethoxymethylsilane, N-ethyl-4-amino-3,3-dimethylbutyltrimethoxy-silane, N-(cyctohexyl)-3-aminopropyltrimethoxysilane, N-(2-aminoethyl)-3-aminopropyitrimethoxysilane, N-(2-aminoethyl)-3-aminopropyltriethoxy-silane, N-(2-aminoethyl)-3-aminopropylmethyldimethoxysilane, aminopropyltriethoxysilane, bis-(3-trimethoxysilyl-2-methylpropyl)amine, N-(3′-trimethoxysilylpropyl)-3-amino-2-methylpropyltrimethoxysilane, gamma-isocyanatopropyltriethoxysilane, gamma-isocyanatopropyltrimethoxysilane, gamma-isocyanatopropyldimethoxysilane, gamma-isocyanatopropyldiethoxysilane, and the like.

A catalyst will ordinarily be used to prepare the isocyanate-terminated PUR prepolymers. Condensation catalysts are generally employed to prepare the PUR. These catalysts may also catalyze the cure (hydrolysis followed by crosslinking) of the SPUR resin component of the moisture-curable composition. Suitable condensation catalysts include, but are not limited to, the dialkyltin dicarboxylates such as dibutyltin dilaurate and dibutyltin acetate, tertiary amines, the stannous salts of carboxylic acids, such as stannous octoate and stannous acetate, and the like. In one embodiment of the present invention, dibutyltin dilaurate catalyst is used in the production of the PUR prepolymer. Other useful catalysts include zirconium-containing and bismuth-containing complexes such as K-KAT XC6212, K-KAT XC-A209 and K-KAT 348, supplied by King Industries, Inc., aluminum chelates such as the TYZOR® types, available from Dorf Ketal company, and the KR types, available from Kenrich Petrochemical, Inc., and other organometallic catalysts, e.g., those containing a metal such as Zn, Co, Ni, Fe, Ti, K, Cu, Mn, Zr, and the like. Still other examples of suitable catalysts include, but are not limited to, zinc (II) acetate, zinc (II) 2-ethylhexanoate, zinc (II) laurate, zinc (II) oleate, zinc (II) naphthenate, zinc (II) acetylacetonate, zinc (II) salicylate, manganese (II) 2-ethylhexanoate, iron (III) 2-ethylhexanoate, iron (III) acetylacetonate, chromium (III) 2-ethylhexanoate, cobalt (II) naphthenate, cobalt (II) 2-ethylhexanoate, copper (II) 2-ethylhexanoate, nickel (II) naphthenate, phenylmercuric neodecanoate, lead (II) acetate, lead (II) 2-ethylhexanoate, lead (II) neodecanoate, lead (II) acetylacetonate, aluminum lactate, aluminum oleate, aluminum (III) acetylacetonate, diisopropoxytitanium bis(ethylacetoacetate), dibutoxytitanium bis(ethyl-acetoacetate), dibutoxytitanium bis(acetylacetonate), potassium acetate, potassium octanoate; triethylamine, tributylamine, N-ethyldiisopropylamine, N,N,N′,N′-tetramethylethylenediamine, pentamethyldiethylenetriamine and higher homologs thereof, N,N,N′,N′-tetramethylpropylenediamine, pentamethyldipropylenetriamine and higher homologs thereof, N,N,N′,N′-tetramethyl-1,3-butanediamine, N,N,N′,N′-tetramethyl-1,6-hexanediamine, bis(dimethylamino) methane, N,N-dimethylbenzylamine, N,N-dimethylcyclohexylamine, N-methyldicyclohexylamine, N,N-dimethylhexadecylamine, bis(N,N-diethylaminoethyl) adipate, 2,2′-dimorpholinodiethyl ether (DMDEE), 1,4-diazabicyclo[2.2.2]octane (DABCO), 1,8-diazabicyclo[5.4.0]undec-7-ene (DBU), 1,5-diazabicyclo[4.3.0]non-5-ene (DBN), N-methyl-morpholine, N-ethylmorpholine.

In another embodiment, moisture-curable SPUR resins can be obtained from a hydroxyl-terminated PUR prepolymer. A moisture-curable SPUR resin can, as previously indicated, be prepared by reacting a hydroxyl-terminated PUR prepolymer with an isocyanatosilane. The hydroxyl-terminated PUR prepolymer can be obtained in substantially the same manner employing substantially the same materials, i.e., polyols, polyisocyanates and optional catalysts (preferably condensation catalysts), described above for the preparation of isocyanate-terminated PUR prepolymers. The one major difference in these reactions is that the polyol and polyisocyanate are provided in a ratio that will result in hydroxyl-termination in the resulting prepolymer. Thus, e.g., in the case of a diol and a diisocyanate, a molar excess of the former will be used thereby resulting in hydroxyl-terminated PUR prepolymer.

Useful silylation reactants for the hydroxyl-terminated SPUR resins are those containing isocyanate termination and readily hydrolyzable functionality, e.g., 1 to 3 alkoxy groups. Suitable silylating reactants are the isocyanatosilanes of the general formula:

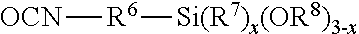

wherein R⁶ is an alkylene group of up to 12 carbon atoms, optionally containing one or more heteroatoms, each R⁷ is the same or different alkyl or aryl group of up to 8 carbon atoms, each R⁸ is the same or different alkyl group of up to 6 carbon atoms and x is 0, 1 or 2. In one embodiment, R⁶ possesses 1 to 4 carbon atoms, each R⁸ is the same or different methyl, ethyl, propyl or isopropyl group and x is 0.

Specific isocyanatosilanes that can be used to react with hydroxyl-terminated PUR prepolymers to provide moisture-curable SPUR resins include, but are not limited to, isocyanatopropyltrimethoxysilane, isocyanatoisopropyltrimethoxysilane, isocyanato-n-butyltrimethoxysilane, isocyanato-t-butyltrimethoxysilane, isocyanatopropyltriethoxysilane, isocyanatoisopropyltriethoxysilane, isocyanato-n-butyltriethoxysilane, isocyanato-t-butyltriethoxysilane, isocyanatopropylmethyldimethoxysilane, isocyanatomethylmethydimethoxysilane, isocyanatopropylmethyldiethoxysilane, isocyanatoisopropyldimethylmethoxysilane, isocyanatobutylphenyldimethoxysilane, 2-(4-isocyanatophenyl)ethylmethyldimethoxysilane, and the like.

The polymer may, in various embodiments, have a general formula of:

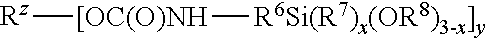

where R^{z} is an organic polymer fragment, R⁶, R⁷, and R⁸ are as described above, and y is 1 to 6. In one embodiment, the organic polymer fragment is a polymer fragment containing at least one urethane group.

The curable composition may optionally contain additives, such as pigments, fillers, curing catalysts, dyes, plasticizers, thickeners, coupling agents, extenders, volatile organic solvents, wetting agents, tackifiers, crosslinking agents, thermoplastic polymers, a thixotropic agent, an antioxidant, a flame retardant, and UV stabilizers. The additives may be used in any suitable quantities familiar to a skilled person in the field as may be useful for a particular purpose or intended application.

The curable composition may include a suitable catalyst to promote curing of the selected polymer resin system. The catalyst is not particularly limited and can be selected based on the polymer resin employed in the curable composition. Suitable cure catalysts include, but are not limited to, organometallic catalysts, amine catalysts, and the like. Preferably, the catalyst is selected from the group consisting of organic tin compounds, zirconium complex, aluminum chelate, titanic chelate, organic zinc, organic cobalt, organic iron, organic nickel and organobismuth, and mixtures thereof. Amine catalysts are selected from the group consisting of primary amine, secondary amine, tertiary amine and aminosilane and mixtures thereof. The catalyst can be a mixture of organometallic catalyst and amine catalyst.

Representative examples of catalysts include, but are not limited to, dibutyltin oxide, dibutyltin dilaurate, dioctyltin dilaurate, dioctyltin dineodecanoate, dimethyltin dineodecanoate, dioctyltin acetylacetonate, dioctyltin oxide, dibutyl tin oxide, dibutyltin diacetate, stannous octoate, stannous acetate, stannous oxide, morpholine, 3-aminopropyltrimethoxysilane, 2-(aminoethyl)-3-aminopropyltrimethoxysilane, tri-isopropylamine, bis-(2-dimethylaminoethyl) ether and piperazine. Other useful catalysts include zirconium-containing, aluminum-containing and bismuth-containing complexes such as K-KAT™ XC6212, K-KAT™ 5218 and K-KAT™ 348, supplied by King Industries, Inc., titanium chelates such as the TYZOR® types, available from Dorf Ketal, the KR™ types, available from Kenrich Petrochemical, Inc., amines such as NIAX™ A-99 amine, available from Momentive Performance Materials, Inc., and the like.

The catalyst may be present in the curable composition in an amount of from about 0.001 weight percent to about 5 weight percent based on the total weight of the composition, from about 0.05 weight percent to about 3 weight percent based on the total weight of the composition, or from about 0.1 weight percent to about 2 weight percent based on the total weight of the composition.

The compositions may include other additives. In one embodiment, the compositions can include fillers. Examples of suitable fillers suitable for the compositions include, but are not limited to, for example, ground, precipitated and colloidal calcium carbonates which is treated with compounds such as stearate or stearic acid, reinforcing silicas such as fumed silicas, precipitated silicas, silica gels and hydrophobized silicas and silica gels; crushed and ground quartz, alumina, aluminum hydroxide, titanium hydroxide, diatomaceous earth, iron oxide, carbon black and graphite or clays such as kaolin, bentonite or montmorillonite, talc, mica, and the like. In one embodiment, the amount of filler is from 0.1 weight percent to about 90 weight percent of the total composition. In yet another embodiment, the amount of filler is from about 5 weight percent to about 60 weight percent of the total composition. In still another embodiment, the amount of filler is from about 10 weight percent to about 40 weight percent of the total composition. The filler may be a single species or a mixture of two or more species.

The compositions may include a plasticizer. Exemplary plasticizers include, but are not limited to, phthalates, diproplyene and diethylene glycol dibenzoates, alkylsulphonate phenols, alkyl phenathrenes, alkyl/diaryl phosphates and mixtures thereof and the like. The moisture-curable resin composition of the present invention can include various thixotropic or anti-sagging agents. Various castor waxes, fumed silica, treated clays and polyamides typify this class of additives. Stabilizers can be incorporated into the moisture-curable resin composition of this invention include, for example, hindered amine and dialkylhydroxyamine. Adhesion promoters are useful in the curable composition of the present invention, e.g., alkoxysilane adhesion promoters.

Examples of plasticizers that are suitable for the curable compositions herein include, but are not limited to phthalates, dipropylene and diethylene glycol dibenzoates and mixtures thereof, epoxidized soybean oil, and the like. Dioctyl and diisodecylphthalate are commercially available under the trade names Jayflex DOP and JayFlex DIDP from Exxon Chemical. The dibenzoates are available as Benzoflex 9-88, Benzoflex 9-88SG, Benzoflex 50 and Benzoflex 400 from Velsicol Chemical Corporation. Epoxidized soybean oil is available from Houghton Chemical Corporation as Flexol EPO. Plasticizer can be present in the moisture-curable composition at a level of from 0 to about 50, and preferably from about 5 to about 15, weight parts per 100 weight parts of the total composition.

The compositions may optionally include a solvent. Useful solvents include, but are not limited to, aromatic and aliphatic esters and ketones. In one embodiment, the solvent is present in amounts of from about 0.1 to about 20, from about 0.5 to about 5, or from about 1 to about 3 weight parts per 100 weight parts of the curable composition of the invention. In one embodiment, the composition is free of a solvent and provided as a 100% solids composition.

In one embodiment, the composition may further include an adhesion promoter. Examples of suitable adhesion promoters include silane type adhesion promoters. The silane adhesion promoters are silanes that differ from the nitrile silanes. Examples of suitable silane adhesion promoters includes aminosilanes, glycidoxysilanes, isoxyano-functional silanes, vinyl functional silane, and the like. Examples of suitable silane adhesion promoters include, but are not limited to, N-2-aminoethyl-3-aminopropyltrimethoxysilane, N-2-aminoethyl-3-aminopropyltriethoxysilane, 1,3,5-tris(trimethoxysilylpropyl) isocyanurate, gamma-aminopropyltriethoxysilane, gamma-aminopropyltrimethoxysilane, bis-gamma-trimethoxysilypropyl)amine, N-Phenyl-gamma-aminopropyltrimethoxysilane, triaminofunctionaltrimethoxysilane, gamma-aminopropylmethyldiethoxysilane, gamma-aminopropylmethyldiethoxysilane, gamma-methacryloxypropyltrimethoxysilane, gamma-methylaminopropyltrimethoxysilane, gamma-glycidoxypropylethyldimethoxysilane, gamma-glycidoxypropyltrimethoxysilane, gamma-glycidoxyethyltrimethoxysilane, beta-(3,4-epoxycyclohexyl) propyltrimethoxysilane, beta-(3,4-epoxycyclohexyl)ethyltrimethoxysilane, beta-(3,4-epoxycyclohexyl)ethyltriethoxysilane beta-(3,4-epoxycyclohexyl)ethylmethyldimethoxysilane, gamma-isocyanatopropyltriethoxysilane alpha-isocyanatopropylmethyldimethoxysilane, gamma-acryloxypropyltrimethoxysilane, gamma-methacryloxypropylmethyldimethoxysilane, 4-amino-3,3,-dimethylbutyltrimethoxysilane, and N-ethyl-3-trimethoxysilyl-2-methylpropanamine, vinyltrimethoxysilane, mixtures of two or more thereof, and the like.

Examples of suitable silane adhesion promoters include, but are not limited to, available adhesion promoters would include but are not limited to various silanes such as Silquest® A-1120 silane, Silquest® A-1110 silane, Silquest® A-2120 silane, Silquest® A-1170 silane; epoxysilanes such as Silquest® A-187 silane; Silquest® A-597 silane, Silquest® A-599 silane, Silquest® A-1891 silane, and Silquest® A-171 silane, available from Momentive Performance Materials Inc., and combinations of two or more thereof.

The adhesion promoter can be added to the composition in ranges of from about 0.1 weight percent to about 20 weight percent. In one embodiment of the invention, the adhesion promoter ranges from about 0.3 weight percent to about 10 weight percent of the total composition. In another embodiment of the invention, the adhesion promoter ranges from about 0.5 weight percent to about 5 weight percent of the total composition.

The curable composition comprising the nitrile silane can be prepared by mixing the components together. For curable compositions that may be provided as two part compositions, the nitrile silane can be added to one or both of the compositions prior to mixing to form the cured material. In one embodiment, the nitrile silane may be mixed with a metal oxide additive (e.g., silica, fumed silica, etc.) and/or plasticizer prior to addition to the polymer resin component of the composition.

The curable compositions can be applied to a substrate and cured by the appropriate curing mechanism for the polymer resin system. The compositions comprising the nitrile silane additive have excellent adhesion to a variety of substrates. The substrate can be selected from a polymeric substrate or an inorganic substrate. Examples of suitable polymeric substrates include, but are not limited to, phenol resins, epoxy resins, polymethyl(meth)acrylate (PMMA), polyesters, ketone ethyl esters (KEE), polycarbonates (PC) polymers of ethylene, polystyrene, and ABS resins (acrylonitrile-butadiene-styrene resins), films of plastics such as acrylic resin, polyvinyl alcohol, polyvinyl chloride, polyethylene terephthalate (PET), polyurethanes including polyurethane foam as used for insulation of roofs, tanks and pipes, polyimides, acrylic polymer filled with aluminum trihydrate, polycarbonates, polyetherimides, modified polyphenyleneoxides, and the like. Still other solid polymeric substrates of the present invention include synthetic and natural rubber, silicon, and silicone polymers. Examples of metal substrates include zinc, zinc coated substrates, steel, Aluzinc coated substrates, galvanized steel, and the like.

In one embodiment, the plastic substrates have a surface energy of from about 30 mJ/m² to about 65 mJ/m², from about 35 mJ/m² to about 60 mJ/m², or from about 40 mJ/m² to about 50 mJ/m².

In one embodiment, the plastic substrates comprise an electron withdrawing functional group. Examples of electron withdrawing groups include, but are not limited to, a halogen, an ester, an ether, an amide, a thiol, an aldehyde, a nitro group, a halo-substituted alkyl, and the like.

In embodiments, the curable compositions have a wet peel strength when adhered to a plastic or zinc-containing substrate, as measured according to ASTM C794, that is at least 50% greater than a composition without the nitrile silane. In embodiments, the curable composition has a wet peel strength that is at least 60% greater, at least 70% greater, at least 80% greater, at least 90% greater, at least 100% greater, at least 125% greater, at least 150% greater, at least 200% greater, or at least 225% greater than that of a composition without the nitrile silane. In one embodiment, the curable composition has a wet peel strength that is from 50% to about 350% greater than a composition without the nitrile silane.

The curable composition comprising the nitrile silane can be applied to a solid polymeric substrate as a coating, a sealant, an adhesive, and the like. The curable composition can be applied to a substrate by any suitable application method know in the art, including rolling, spraying, extruding, brushing, and so forth. In some cases, the curable resin-forming composition can be laminated onto the solid polymeric substrate or can be coated to form a film thereon. Such coating processes commonly use machines having an application section and a metering section. Careful control of the amount and thickness of the curable resin-forming composition obtains optimized layers without waste of material. A number of coating machines are known such as tension sensitive coaters, for example, coaters using a metering rod, brush coating methods, air knife coaters, etc. Such coating machines can be used to coat one or all sides of a polymeric substrate.

It will be appreciated that the composition can be employed to adhere a first substrate to another substrate.

In another aspect, provided is a primer composition comprising the nitrile silane. The primer composition comprises the nitrile silane disposed in a solvent. The solvent can be selected from an organic solvent or an aqueous solvent. Examples of the organic solvent include, but are not limited to, diacetone alcohol, propylene glycol monomethyl ether; ethylene glycol monomethyl ether, propylene glycol monoethyl ether, ethylene glycol monoethyl ether, isobutyl alcohol, ethanol, isopropyl alcohol, n-butyl alcohol, n-propyl alcohol, acetone, methyl ethyl ketone, methyl isobutyl ketone, acetylacetone, ethyl acetate, butyl acetate, xylene, toluene, and the like. The primer composition with the organic solvent may optionally comprise water. The primer may comprise the nitrile silane in an amount of from about 0.1 to about 10 wt. %, from about 0.5 wt. % to about 7.5 wt. %, or from about 1 wt. % to about 5 wt. % based on the total weight of the primer composition. The solvent may be present in an amount of from about 80 wt. % to about 99.9 wt. % based on the total weight of the primer composition. In one embodiment, the primer comprises an organic solvent and water, where the water may be present in an amount of from about 0.1 to about 10 wt. %, from about 1 wt. % to about 7.5 wt. %, or from about 2.5 wt. % to about 5 wt. % based on the total weight of the primer composition. In one embodiment, the primer composition is aqueous and comprises water in an amount of from about 60 wt. % to about 99.9 wt. %., from about 70 wt. % to about 95 wt. %, or from about 80 wt. % to about 90 wt. %.

The primer can be employed to enhance the adhesion of a coating composition to a substrate. In the present technology, the primer with the nitrile silane can be applied to a surface and a curable polymer composition can be applied over the nitrile silane. The curable polymer composition employed when a primer composition containing a nitrile silane is employed comprise a curable polymer as described above except that it may be either free of the nitrile silane or can include a nitrile silane as described above. In one embodiment, the primer can be employed to enhance the bonding of substrates. A layer of primer composition can be applied to a surface of each of the substrates to be bonded together. A layer of curable polymer can be provided to one of the substrates (over the primer layer), and the two substrates can be bonded to one another. The primer can optionally be dried prior to application of the curable polymer resin.

The present technology has been described in the foregoing detailed description and with reference to various aspects and embodiments. The technology may be further understood with reference to the following Examples. The Examples are intended to further illustrate aspects and embodiments of the present technology and not necessarily to be limited to such aspects or embodiments.

### EXAMPLES

### Examples 1 and 2

Curable compositions were prepared as shown in Table 1. The sealants were applied to a PET substrate, an Aluzinc substrate, and an aluminum substrate. The substrates were wiped with isopropanol before application of the sealant. The sealant was applied to a thickness of 4 mm. The samples were cured for three weeks at 23 C and 50% relative humidity. Following curing, the substrates were immersed in water for one week at room temperature. Peel strength (180) was measured following water immersion according to ASTM C794. The peel strength and mode of failure (e.g., cohesive or adhesive) is shown in Table 2.

TABLE 1

| | | CE-1 | Ex. 1 | CE-2 | Ex. 2 |
|---|---|---|---|---|---|
| | | Wt. | Wt. | Wt. | Wt. |
| Component | Source | (kg) | (kg) | (kg) | (kg) |
| SPUR+ 1020 Prepolymer | Momentive | 54.00 | 54.00 | — | — |
| | Performance | | | | |
| | Materials Inc. | | | | |
| SPUR+ 1050 Prepolymer | Momentive | — | — | 22.07 | 22.07 |
| | Performance | | | | |
| | Materials Inc. | | | | |
| HALS | Everlight/Eversorb | 0.4 | 0.4 | 0.20 | 0.20 |
| | 90 | | | | |
| UV Absorber | Everlight/Eversorb | 0.4 | 0.4 | 0.20 | 0.20 |
| | 74 | | | | |
| Non-phthalate plasticizer | BASF/EFKA PL | 31.80 | 31.80 | 17.50 | 17.50 |
| | 5646 | | | | |
| Calcium carbonated (treated; | OB 1250 | | | 53.90 | 53.90 |
| 3 mm) | | | | | |
| Titanium dioxide | Dupont/R902 | | | 1.10 | 1.10 |
| Fumed Silica | Aerosil R812S | 9.00 | 9.00 | — | — |
| Fumed Silica | TS-720 | | | 1.10 | 1.10 |
| Silquest ® A-171 | Momentive | 3.30 | — | 3.30 | — |
| | Performance | | | | |
| | Materials Inc. | | | | |
| Nitrile silane | Momentive | — | 3.30 | — | 3.30 |
| (2-cyanoethyltrimethoxysilane) | Performance | | | | |
| | Materials Inc. | | | | |
| Silquest ® A-Link 600 | Momentive | 1.00 | 1.00 | — | — |
| | Performance | | | | |
| | Materials Inc. | | | | |
| Silquest ® 1110 (gamma- | Momentive | | | 0.57 | 0.57 |
| aminopropyltrimethoxysilane) | Performance | | | | |
| | Materials Inc. | | | | |
| Dibutyl tin dilaurate | Momentive | 0.04 | 0.04 | 0.06 | 0.06 |
| | Performance | | | | |
| | Materials Inc. | | | | |
| Total | | 100 | 100 | 100 | 100 |

SPUR+ 1020: silylated polyurethane resin (viscosity around 50,000 cP)
SPUR+ 1050: silylated prepolymer (viscosity around 35,000 mPa)
EFKA PL 5456: 1,2-Cyclohexane dicarboxylic acid, diisononyl ester
Silquest ® A-171: vinyltrimethoxy silane
A-Link 600: aminosilane
Silquest ® 1110: gamma-aminopropyltrimethoxysilane

TABLE 2

| | CE-1 | | Ex. 1 | | | CE-2 | | Ex. 2 | | |
|---|---|---|---|---|---|---|---|---|---|---|
| | Wet | | Wet | | | Wet | | Wet | | |
| | Peel | | Peel | | % | Peel | | Peel | | % |
| Substrate | (lbf/in) | Failure | (lbf/in) | Failure | Improvement | (lbf/in) | Failure | (lbf/in) | Failure | Improvement |
| PET | 10.6 | AF | 18.6 | CF | 75 | 1.5 | AF | 4.36 | AF | 191 |
| Aluzinc | 7.1 | AF | 23.5 | CF | 229 | 4.25 | AF | 13.91 | CF | 227 |
| Aluminum | 20. | CF | 26.3 | CF | 26 | 17 | CF | 11.4 | AF | −33 |

AF: Adhesive failure
CF: Cohesive failure

### Examples 3 and 4

Peel samples were prepared as shown in Table 3, and adhesion was evaluated on a PVC substrate. Dry peel was evaluated after three weeks of curing at 23 C and 50% relative humidity. Wet peel was evaluated as described for Examples 1 and 2. The peel test results and mode of failure on a PVC substrate are shown in Table 4.

TABLE 3

| | CE-3 | Ex. 3 | Ex. 4 |
|---|---|---|---|
| Component | Wt. % | Wt. % | Wt. % |
| SPUR+ 1020 prepolymer | 54 | 54 | 54 |
| Label free stabilizer | 0.8 | 0.8 | 0.8 |
| (Addworks IBC760) | | | |
| DINCH plasticizer | 30.8 | 30.8 | 30.8 |
| Fumed Silica (Aerosil RX | 9 | 9 | — |
| 300) | | | |
| Fumed Silica (Aerosil | | | 9 |
| 812S) | | | |
| Silquest ® A-1110 | 1 | 1 | 1 |
| Nitrile Silane (2- | — | 1 | 1 |
| cyanoethyltrimethoxysilane) | | | |
| SIlquest ® A-171 | 3 | 3 | 3 |
| Dimethyl tin | 0.4 | 0.4 | 0.4 |
| dineodecanoate | | | |
| (Fomrez ® UL-28) | | | |
| Total | 100 | 100 | 100 |

DINCH plasticizer: 1,2-Cyclohexane dicarboxylic acid, diisononyl
Fomrez ® UL-28: Dimethyl tin dineodecanoate

TABLE 4

| | CE-3 | Ex. 3 | Ex. 4 |
|---|---|---|---|
| Dry Peel (lbf/in) | 17 | 14.6 | 15.6 |
| Failure Mode (dry) | 100% CF | 100% CF | 100% CF |
| Wet Peel (lbf/in) | 6 | 15.5 | 21 |
| % Increase (Wet Peel) | — | 158% | 250% |
| Failure Mode (wet) | 0% CF | 100% CF | 100% CF |

### Example 5

The composition of Example 5 was evaluated for adhesion on ketone ethyl ester (KEE) and polyvinyl chloride. A patch of adhesive (1 inch by 2 inch) with a thickness of 4 mm was disposed on the embossed side of the ketone ethyl ester membrane and on the PVC membrane. The adhesive was cured for one week at 23 C and 50% relative humidity. The sample was peeled manually. The results are shown in Table 5.

TABLE 5

| Component | Ex. 5 (Wt. %) |
|---|---|
| SPUR+ 1020 prepolymer | 54 |
| Label free stabilizer (Addworks IBC760) | 0.8 |
| DINCH plasticizer | 30.8 |
| Fumed Silica (Aerosil RX 300) | 9 |
| Silquest A-1110 | 1 |
| Nitrile Silane (2-cyanoethyltrimethoxysilane) | 5 |
| SIlquest A-171 | 3 |
| Dimethyl tin dineodecanoate (Fomrez ® UL- | 0.4 |
| 28) | |
| Substrate | Failure Mode |
| PVC Membrane | 50% CF |
| KEE membrane | 100% CF |

IBC760: mixture of a UV absorber, hindered amine light stabilizer (HALS) and antioxidant

### Example 6

The components of table 6 are mixed together with a FlackTek SpeedMixer® until a clear gel is formed. The gel is placed in an open pan in a vented oven at 135° C. for two hours and cooled. In Table 7, adhesive formulations (Ex. 7 and Ex. 8) are prepared by mixing first SPUR+ prepolymer, the stabilizer and Silquest® A-171. Blend Ex. 6 is added and mixed. Aminosilane and Metal catalyst are added last. In Ex. 7, blend of Ex. 6 is not heated; in Ex. 8, the blend of Ex. 6 is heated prior to addition to the composition. The adhesion of compositions of Ex. 7 and Ex. 8 to PVC was then evaluated.

TABLE 6

| | Ex 6 |
|---|---|
| Component | wt % |
| RX300 | 22.06 |
| DINCH | 65.69 |
| Plasticizer | |
| Nitrile silane | 12.25 |
| | 100.00 |

TABLE 7

| | Ex. 7 (wt %) | Ex. 8 (wt %) |
|---|---|---|
| Blend Ex 6 | 40.8 | 40.8 |
| SPUR+ 1020 Prepolymer | 54 | 54 |
| Label Free stabilizer (Addworks | 0.8 | 0.8 |
| IBC760) | | |
| Silquest A-171 | 3 | 3 |
| Silquest A1110 | 1 | 1 |
| Fomrez UL-28 | 0.4 | 0.4 |
| Process of Blend Ex 6 | no heating step | heating step |
| Dry Peel (lbf/in) | 14 | 13.6 |
| Failure Mode (dry) | 90% CF | 100% CF |
| Wet Peel (lbf/in) | 7.5 | 15.2 |
| Failure Mode (wet) | 10% CF | 100% CF |

### Example 9

Adhesion to acrylonitrile-butadiene-styrene (ABS) plastic substrates was evaluated. The compositions are described in Table 8. Ex. 9 includes a nitrile silane; CE-4 does not include a nitrile silane. The compositions were applied to an ABS substrate. The substrates were wiped with isopropanol before application of the sealant. The sealant was applied to a thickness of 4 mm. The samples were cured for three weeks at 23° C. and 50% relative humidity. Following curing, the substrates were immersed in water for one week at room temperature. Peel strength (180) was measured following water immersion according to ASTM C794. The peel strength and mode of failure (e.g., cohesive or adhesive) is shown in Table 9.

TABLE 8

| | | Ex. 9 | CE-4 |
|---|---|---|---|
| | | Wt. | Wt. |
| Ingredients | Supplier | (kg) | (kg) |
| SPUR+ ™ 1020 | Momentive | 54.00 | 54.00 |
| Prepolymer | | | |
| Eversorb HP6 | Everlight | 0.80 | 0.40 |
| Hexamoll Dinch | BASF | 31.80 | 31.80 |
| Fumed Silica Aerosil R812S | Evonik | 9.00 | 9.00 |
| Silquest ™ A-171 silane | Momentive | | 3.30 |
| Nitrile Silane (2- | Momentive | 3.30 | |
| cyanoethyltrimethoxysilane) | | | |
| Silquest ™ A-Link 600 silane | Momentive | 1.00 | 1.00 |
| DBTDL Tin catalyst | Momentive/ | 0.40 | 0.52 |
| | Fomrez | | |
| | Catalyst SUL-4 | | |
| | | 100 | 100 |

TABLE 9

| | CE-4 | | Ex. 9 | | | CE-4 | | Ex. 9 | | |
|---|---|---|---|---|---|---|---|---|---|---|
| | Dry | | Dry | | | Wet | | Wet | | |
| | Peel | | Peel | | % | Peel | | Peel | | % |
| Substrate | (lbf/in) | Failure | (lbf/in) | Failure | Improvement | (lbf/in) | Failure | (lbf/in) | Failure | Improvement |
| ABS | 4.5 | AF | 21.05 | CF/AF | 370 | 7.4 | AF/CF | 24.5 | CF | 231 |

### Example 10

The composition in Table 10 was adhered to a PVC substrate. The compositions in Table 10 further includes a calcium carbonate filler. The compositions were applied as discussed above with respect to the prior examples.

TABLE 10

| | Ex. 10 | CE-5 |
|---|---|---|
| Components | Wt % | Control wt % |
| Spur+ 1015 prepolymer | 39.36 | 39.21 |
| Plasticizer: DIDP | 14.2 | 15.3 |
| Stabilizer: Eversorb HP 1 | 0.8 | 0.82 |
| Silquest A-171 | 0.59 | 0.6 |
| precipitated calcium carbonate | 23.62 | 23.46 |
| (Ultra pflex) | | |
| ground calcium carbonate (Hi- | 15.74 | 15.86 |
| pflex) | | |
| Titanium oxide R960 | 1.18 | 1.19 |
| Cabosil TS720 Fumed silica | 2.36 | 2.34 |
| Silquest A-1120J silane | 0.59 | 0.61 |
| TIBCAT 300 Tin catalyst | 0.3 | 0.3 |
| DINCH plasticizer | 0.3 | 0.3 |
| Nitrile Silane (2- | 1 | |
| cyanoethyltrimethoxysilane) | | |
| Total | 100 | 100 |
| wet peel test on PVC(lb/inch) | 52.7 | 26.3 |
| (ASTM C794) | | |
| % improvement | 100 | |

The following compositions are examples of compositions that may also be prepared in accordance with aspects of the present technology.

TABLE 8
Polyurethane

| | | |
|---|---|---|
| Base | polypropylene ether triol | 29 |
| | capped with ethylene | |
| | oxide (6000-7000 MW) | |
| | isocyanate MDI | 51.6 |
| | antioxidant | 0.4 |
| | fumed silica | 0.5 |
| | filler | 13.5 |
| | molecular sieve | 5 |
| | Total (base) | 100 |
| | | wt % |
| curative | polyols | 58.33 |
| | amine | 0.93 |
| | fillers | 30.84 |
| | fumed silica | 0.37 |
| | phosphorus polyol | 7.47 |
| | Aminosilane Silquest | 0.93 |
| | 1120 | |
| | nitrile silane | 0.93 |
| | urethane catalyst | 0.19 |
| | Total (curative) | 100 |

TABLE 9
Epoxy

| | | |
|---|---|---|
| Part A | Epoxy resin Araldite GY-6010 | 100 |
| | Epoxy silane | 1 |
| | Nitrile silane | 1 |
| Part B | Amine hardener Jeffamine | 32 |
| | D230 | |
| | accelerator 399 | |

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of a curable composition with a cyanoalkylalkoxysilane and substrates having adhered thereto a cured material formed from such compositions. Modifications may occur to those skilled in the art and to those who may make and use the invention. The disclosed embodiments are merely for illustrative purposes and not intended to limit the scope of the invention or the subject matter set forth in the claims.

What is claimed is:

1. A substrate having adhered to at least a portion of a surface of the substrate a cured composition obtained from a curable composition, wherein the curable composition comprises (a) a curable resin comprising a polymer; and (b) a nitrile silane.

2. The substrate of claim 1, wherein the nitrile silane is a cyanoalkylalkoxysilane of the formula: 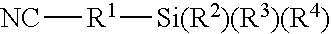
where R¹ is selected from a C1-C20 bivalent hydrocarbon group; R², R³, and R⁴ are each independently selected from C1-30 monovalent hydrocarbon, a halide, and —OR⁵, where R⁵ is independently selected from a C1-30 monovalent hydrocarbon, with the proviso that at least one of R², R³, and R⁴ is selected from —OR⁵.

3. The substrate of claim 2, wherein R¹ is selected from a C1-C20 alkylene; R², R³, and R⁴ are each independently selected from a C1-C20 alkyl, a C4-C20 cycloalkyl, and a C6-C30 aryl; and R⁵ is independently selected from a C1-C20 alkyl.

4. The substrate of claim 2, wherein R¹ is selected from a C1-C20 alkylene; each of R², R³, and R⁴ is selected from a C1-C10 alkyl, and R⁵ is selected from a C1-C10 alkyl.

5. The substrate of claim 2, wherein R¹ is selected from a C1-C4 alkylene, and each of R², R³, and R⁴ is selected from —OR⁵, where R⁵ is independently selected from a C1-C4 alkyl.

6. The substrate of claim 2, wherein the cyanoalkylalkoxysilane is selected from 2-cyanoethyltrimethoxysilane, 2-cyanoethyltriethoxysilane, 2-cyanoethyltripropoxysilane, 2-cyanoethyldimethoxymethylsilane, 2-cyanoethyldimethoxyethylsilane, 2-cyanoethyldiethoxymethylsilane, 2-cyanoethyldiethyoxyethylsilane, 3-cyanopropyltrimethoxysilane, 3-cyanopropyltriethoxysilane, 3-cyanopropyltripropoxysilane, 3-cyanopropyldimethoxymethylsilane, 3-cyanopropyldimethoxyethylsilane, 3-cyanodiethoxymethylsilane, 3-cyanopropyldiethoxyethylsilane, or a combination of two or more thereof.

7. The substrate of claim 1, wherein the cyanoalkylalkoxysilane is present in an amount of from about 0.1 wt. % to about 20 wt. % based on the total weight of the curable composition.

8. The substrate of claim 1, wherein the cyanoalkylalkoxysilane is present in an amount of from about 0.5 wt. % to about 10 wt. % based on the total weight of the curable composition.

9. The substrate of claim 1, wherein the cyanoalkylalkoxysilane is present in an amount of from about 1 wt. % to about 5 wt. % based on the total weight of the curable composition.

10. The substrate of claim 1, wherein the curable resin is selected from a polymer selected from a polyepoxide; a polyolefin; a polyvinylchloride; a polyester; a polyurethane; a polyamide; a polyfluoroalkene; a polyether; a polyacrylate; a polymethacrylate; a polysiloxane; a silylated polyol; a silylated polyether; a silylated polyurethane; a silane-containing copolymer derived from the copolymerization of an ethylenically unsaturated silane selected from a vinylsilane, an allylsilane, a methallylsilane, an acryloxyalkylsilane, a methacryloxyalkylsilane, and an ethylenically unsaturated monomer selected from an olefinic hydrocarbon, an acrylic acid, a methacrylic acid, an acrylate ester, a methacrylate ester, an ethylenically unsaturated dicarboxylic acid, and/or an anhydride of the ethylenically unsaturated monomer, oligomers, and/or a polymer possessing ethylenic unsaturation; a combination of two or more thereof.

11. The substrate of claim 10, wherein the curable resin is selected from a silylated polyurethane.

12. The substrate of claim 11, wherein the silylated polyurethane is selected from a polymer of the formula: 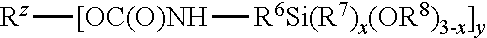
where R^{z} is an organic polymer fragment, R⁶ is an alkylene group of up to 12 carbon atoms, optionally containing one or more heteroatoms, each R⁷ is the same or different alkyl or aryl group of up to 8 carbon atoms, each R⁸ is the same or different alkyl group of up to 6 carbon atoms, x is 0, 1 or 2, and y is 1 to 6.

13. The substrate of claim 11, wherein R¹ is selected from a C1-C20 linear or branched bivalent hydrocarbon group; R², R³, and R⁴ are each independently selected from a C1-C10 alkyl; where R⁵ is selected from a C1-C10 alkyl.

14. The substrate of claim 11, wherein each of R², R³, and R⁴ is selected from a C1-C20 alkyl, a C4-C20 cycloalkyl, a C6-C30 aryl, or —OR⁵.

15. The substrate of claim 11, wherein R¹ is selected from a C1-C20 linear or branched bivalent hydrocarbon group, and each of R², R³, and R⁴ is selected from —OR⁵, where R⁵ is independently selected from a C1-C4 alkyl.

16. The substrate of claim 1, wherein the substrate is selected from a polymeric substrate or an inorganic substrate.

17. The substrate of claim 1, wherein the substrate is a polymeric substrate selected from a phenol resin, an epoxy resin, a polycarbonate (PC), a polyolefin, a polystyrene, an acrylonitrile-butadiene-styrene resin, an acrylic resin, a polyvinyl alcohol, a polyester, a polyvinyl chloride, a polyurethane, a polyimide, a synthetic rubber, a natural rubber, a silicon polymer, or a combination of two or more thereof.

18. The substrate of claim 17, wherein the substrate is selected from a polymethyl(meth)acrylate (PMMA), a ketone ethyl ester (KEE), a polyethylene terephthalate (PET), polyvinyl chloride, acrylonitrile-butadiene-styrene, or a combination of two or more thereof.

19. The substrate of claim 16, wherein the substrate is selected from a zinc coated substrate, steel, an Aluzinc coated substrates, galvanized steel, or a combination of two or more thereof.

20. The substrate of claim 1, wherein the composition further comprises an additive selected from a pigment, a filler, a curing catalyst, a dye, a plasticizer, a thickener, a coupling agent, an extender, a solvent, a wetting agent, a tackifiers, a crosslinking agent, a thermoplastic polymer, an adhesion promoter, a UV stabilizer, or a combination of two or more thereof.

21. The substrate of claim 1, wherein the curable composition is free of a solvent.

22. The substrate of claim 1, wherein the cured composition has a wet peel strength that is at least 50% greater than the same composition that does not contain the nitrile silane when adhered to a polyethylene terephthalate substrate or an Aluzinc substrate, wherein the wet peel strength is measured according to ASTM C794 following one week of immersion in water at a temperature of from about 19° C. to about 25° C.

23. The substrate of claim 1, wherein the cured composition has a wet peel strength that is from 50% to about 350% greater than the same composition that does not contain the nitrile silane when adhered to a polyethylene terephthalate substrate or an Aluzinc substrate, wherein the wet peel strength is measured according to ASTM C794 following one week of immersion in water at a temperature of from about 19° C. to about 25° C.

24. A primer composition comprising a nitrile silane and a solvent.

25. The primer composition of claim 24 wherein the nitrile silane is a cyanoalkylalkoxysilane of the formula: 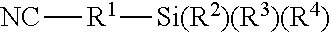
where R¹ is selected from a C1-C20 bivalent hydrocarbon group; R², R³, and R⁴ are each independently selected from C1-30 monovalent hydrocarbon, a halide, and —OR⁵, where R⁵ is independently selected from a C1-30 monovalent hydrocarbon, with the proviso that at least one of R², R³, and R⁴ is selected from —OR⁵.

26. The primer of claim 24, wherein R¹ is selected from a C1-C20 alkylene; R², R³, and R⁴ are each independently selected from a C1-C20 alkyl, a C4-C20 cycloalkyl, and a C6-C30 aryl; and R⁵ is independently selected from a C1-C20 alkyl.

27. The primer of claim 24, wherein R¹ is selected from a C1-C20 alkylene; each of R², R³, and R⁴ is selected from a C1-C10 alkyl, and R⁵ is selected from a C1-C10 alkyl.

28. The primer of claim 24, wherein R¹ is selected from a C1-C4 alkylene, and each of R², R³, and R⁴ is selected from —OR⁵, where R⁵ is independently selected from a C1-C4 alkyl.

29. The primer of claim 24, wherein the cyanoalkylalkoxysilane is selected from 2-cyanoethyltrimethoxysilane, 2-cyanoethyltriethoxysilane, 2-cyanoethyltripropoxysilane, 2-cyanoethyldimethoxymethylsilane, 2-cyanoethyldimethoxyethylsilane, 2-cyanoethyldiethoxymethylsilane, 2-cyanoethyldiethyoxyethylsilane, 3-cyanopropyltrimethoxysilane, 3-cyanopropyltriethoxysilane, 3-cyanopropyltripropoxysilane, 3-cyanopropyldimethoxymethylsilane, 3-cyanopropyldimethoxyethylsilane, 3-cyanodiethoxymethylsilane, 3-cyanopropyldiethoxyethylsilane, or a combination of two or more thereof.

30. The primer composition of claim 24, wherein the solvent is selected from diacetone alcohol, propylene glycol monomethyl ether; ethylene glycol monomethyl ether, propylene glycol monoethyl ether, ethylene glycol monoethyl ether, isobutyl alcohol, ethanol, isopropyl alcohol, n-butyl alcohol, n-propyl alcohol, acetone, methyl ethyl ketone, methyl isobutyl ketone, acetylacetone, ethyl acetate, butyl acetate, xylene, toluene, or a combination of two or more thereof.

31. The primer composition of claim 24 further comprising water.

32. The primer composition of claim 31, wherein the water is present in an amount of from about 0.1 wt. % to about 10 wt. % based on the total weight of the primer composition.

33. The primer composition of claim 24, wherein the solvent is water.

34. The primer composition of claim 24 wherein the nitrile silane is present in an amount of from about 0.1 wt. % to about 10 wt. % based on the total weight of the primer composition.

35. A method of adhering a first substrate to a second substrate comprising applying the primer composition of claim 24 to a surface of the first substrate and to a surface of the second substrate; applying a curable polymer composition over the primer composition on the first or second substrate; and bonding the first and second substrate.
